(19) United States
(12) Patent Application Publication
(10) Pub. No.: US 2011/0216170 A1
(43) Pub. Date: Sep. 8, 2011

(54) THREE-DIMENSIONAL IMAGE VIEWING DEVICE AND THREE-DIMENSIONAL IMAGE DISPLAY DEVICE

(75) Inventor: Yasuhiro DAIKU, Tokyo (JP)

(73) Assignee: CASIO COMPUTER CO., LTD., Tokyo (JP)

(21) Appl. No.: 13/022,570

(22) Filed: Feb. 7, 2011

(30) Foreign Application Priority Data
Mar. 5, 2010 (JP) 2010-049366

(51) Int. Cl. H04N 13/04

(52) U.S. Cl. 348/51; 348/E13.001

(57) ABSTRACT

A three-dimensional image viewing device includes a control panel in which a plurality of pixels are disposed in a predetermined region; a position identifying unit that identifies a right eye position and a left eye position of a user viewing a display screen on which a left eye image and a right eye image are displayed through the predetermined region of the control panel configured to be interposed between the user and the display screen; and a control circuit that controls the plurality of pixels such that at least part of the pixels arranged in a region corresponding to the right eye position identified by the position identifying unit transmits light only from the right eye image and also such that at least part of the pixels disposed in a region corresponding to the left eye position identified by the position identifying unit transmits light only from the left eye image.

### CROSS-REFERENCE TO RELATED APPLICATIONS

This application is based upon and claims the benefit of priority from prior Japanese Patent Application No. 2010-049366, filed Mar. 5, 2010 in Japan, the entire contents of which are hereby incorporated by reference.

### BACKGROUND OF THE INVENTION

1. Field of the Invention

The present invention relates to a technology for eliminating the need of wearing 3D glasses to view three-dimensional images.

2. Description of the Related Art

One of the conventional methods for creating three-dimensional images (still and moving images), i.e., images perceived by a viewer as having a depth, is a polarization filter method. With the polarization filter method, the left and right images having a binocular parallax (a difference between left and right viewpoints) are presented in different polarized lights, which polarization directions cross at a right angle. The viewer sees the images through polarized glasses which are equipped with the left and right polarization filters having polarization transmission axes that match the polarized lights of the left and right images, respectively. However, the polarization filter method allows the viewer to view three-dimensional images only through the polarized glasses. Therefore, for any three-dimensional image presentation, polarized glasses have to be distributed to the viewers.

Japanese Patent Application Laid-Open Publication No. 2009-31683, for example, addresses this problem and discloses a technology for enabling a viewer to see three-dimensional images through a viewing window in the partition facing the three-dimensional image (composed of the right and left images). In the viewing window, a pair of polarization filters for the right and left eyes are provided side by side, and a viewer can see the three dimensional images through this viewing window. With this technology, it is possible to present three-dimensional images to a number of viewers without the need of distributing the polarized glasses to them in advance.

However, the viewing window in the above disclosure is no more than a pair of polarized glasses having a different shape and permanently fixed at a specific position. Therefore, viewers can see the three-dimensional images only from a particular position at which the viewing window is provided.

### SUMMARY OF THE INVENTION

The present invention was devised in consideration of the issues associated with the conventional technology discussed above and aims at enabling a viewer to see three-dimensional images without 3D glasses without being at a specified viewing position(s).

In one aspect, the present invention provides a three-dimensional image viewing device including a control panel having a plurality of pixels arranged in a predetermined region; a position identifying unit that identifies a right eye position and a left eye position of a user viewing a display screen on which a left eye image and a right eye image are displayed, the user viewing the display screen through the predetermined region of the control panel configured to be interposed between the user and the display screen; and a control circuit that controls the plurality of pixels such that at least part of the pixels arranged in a region corresponding to the right eye position identified by the position identifying unit transmits light only from the right eye image, and such that at least part of the pixels arranged in a region corresponding to the left eye position identified by the position identifying unit transmits light only from the left eye image.

In another aspect, the present invention provides a three-dimensional image viewing device including a control panel having a plurality of first pixels for a left eye image and a plurality of second pixels for a right eye image, the plurality of first pixels and the plurality of second pixels being arranged respectively in predetermined regions; a position identifying unit identifying a right eye position and a left eye position of a user viewing a display screen on which the left eye image and the right eye image are displayed, the user viewing the display screen through the predetermined regions of the control panel configured to be interposed between the user and the display screen; and a control circuit controlling the first pixels and the second pixels of the control panel, wherein the first pixels are configured to be switchable between a first mode in which both first light and second light are blocked and a second mode in which the first light is transmitted and the second light is blocked, the first light being light from the left eye image and the second light being light from the right eye image, wherein the second pixels are configured to be switchable between the first mode and a third mode in which the first light is blocked and the second light is transmitted, and wherein the control circuit controls the first pixels and the second pixels in a region that corresponds to the left eye position identified by the position identifying unit such that the first pixels in that region enter the second mode and the second pixels in that region enter the first mode, and controls the first pixels and the second pixels in a region that corresponds to the right eye position identified by the position identifying unit such that the first pixels in that region enter the first mode and the second pixels in that region enter the third mode.

In another aspect, the present invention provides a three-dimensional image viewing device including a control panel having first pixels for a left eye image and second pixels for a right eye image, the plurality of first pixels and the plurality of second pixels being disposed respectively in predetermined regions; a position identifying unit identifying a right eye position and a left eye position of a user viewing a display screen on which the left eye image and the right eye image are displayed, the user viewing the display screen through the predetermined regions of the control panel configured to be interposed between the user and the display screen; and a control circuit controlling the first pixels and the second pixels on the control panel, wherein the first pixels are configured to be switchable between a first mode in which both first light and second light are blocked and a second mode in which the first light is transmitted and the second light is blocked, the first light being light from the left eye image and the second light being light from the right eye image, wherein the second pixels are configured to be switchable between the first mode and a third mode in which the first light is blocked and the second light is transmitted, and wherein the control circuit controls the first pixels and the second pixels so as to generate, on the control panel, a three-dimensional image viewing glasses unit for the user at a position that is determined in accordance with the locations of the right eye and the left eye identified by the position identifying unit.

In another aspect, the present invention provides a three-dimensional image viewing device including a control panel having a plurality of pixels disposed in a predetermined region; a position identifying unit identifying a right eye position and a left eye position of a user viewing a display screen on which a left eye image and a right eye image are alternately displayed in a time-division manner, the user viewing the display screen through the predetermined region of the control panel configured to be interposed between the user and the display screen; and a control circuit that controls the plurality of pixels such that a light transmission state of the pixels disposed in a region corresponding to the left eye position identified by the position identifying unit differs from a light transmission state of the pixels disposed in a region corresponding to the right eye position identified by the position identifying unit.

In another aspect, the present invention provides a three-dimensional image viewing device including a control panel having a plurality of pixels disposed in a predetermined region; a position identifying unit identifying a right eye position and a left eye position of a user viewing a display screen on which a left eye image and a right eye image are alternately displayed in a time-division manner, the user viewing the display screen through the predetermined region of the control panel configured to be interposed between the user and the display screen; and a control circuit that controls the plurality of pixels to generate a three-dimensional image viewing glasses unit on the control panel, the three-dimensional image viewing glasses unit being generated for the user in accordance with the right eye position and the left eye position identified by the position identifying unit.

In another aspect, the present invention provides a three-dimensional image display device including a projector projecting a left eye image and a right eye image on a screen; a control panel having a plurality of pixels disposed in a predetermined region; a position identifying unit identifying a right eye position and a left eye position of a user viewing a display screen, the user viewing the display screen through the predetermined region of the control panel that is configured to be interposed between the user and the screen; and a control circuit that controls the plurality of pixels such that at least part of the pixels disposed in a region corresponding to the right eye position identified by the position identifying unit transmits light only from the right eye image, and such that at least part of the pixels disposed in a region corresponding to the left eye position identified by the position identifying unit transmits light only from the left eye image.

According to at least some of the aspects of the present invention, a viewer who does not wear polarized glasses can view a three-dimensional image displayed with a polarization filter method without being at a specified or preset position.

Other advantages of the invention will be set forth in the description which follows, and in part will be obvious from the description, or may be learned by practice of the invention.

The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a schematic perspective view illustrating the structure of a three-dimensional image display device including a three-dimensional image viewing device according to an embodiment of the present invention.

FIG. 1B is a schematic side view illustrating the structure of the three-dimensional image display device including the three-dimensional image viewing device according to the embodiment of the present invention.

FIG. 2 is a view illustrating the polarization axes of the projected lights from a projection device.

FIG. 3 is a partially cutout enlarged perspective view showing a configuration of a control panel.

FIG. 4 is an exploded perspective view of the control panel.

FIG. 5 is a view illustrating the optical effect of the control panel when the liquid crystal element is in the non-driving mode.

FIG. 6 is a view illustrating the optical effect of the control panel when the liquid crystal element is in the driving mode.

FIG. 7 is a block diagram showing an electrical configuration of the main components of the three-dimensional image display device.

FIG. 8 is a flowchart showing the process of the control panel control.

FIG. 9A is a diagram showing positions of both eyes of a viewer.

FIG. 9B is a diagram showing a left eye visible region and a right eye visible region on a control panel for a viewer.

FIG. 10A is a diagram showing the driving status of a left eye visible region and a right eye visible region on a control panel.

FIG. 10B is a partially enlarged view of FIG. 10A.

FIG. 11A is a diagram showing positions of both eyes of a plurality of viewers.

FIG. 11B is a diagram showing a plurality of polarized glasses units on a control panel for a plurality of viewers.

FIG. 12 is a diagram showing an example of a change of the position where a polarized glasses unit is generated on the control panel.

FIG. 13 is an illustration showing an example of the display device used for a direct view three-dimensional image display device.

FIG. 14 is a flowchart showing the control processes on the control panel when the control panel is used for a time-division three-dimensional image display device.

FIG. 15 is a diagram showing a shutter glasses unit generated on the control panel.

### DETAILED DESCRIPTION OF THE INVENTION

Preferred embodiments of the present invention will be described.

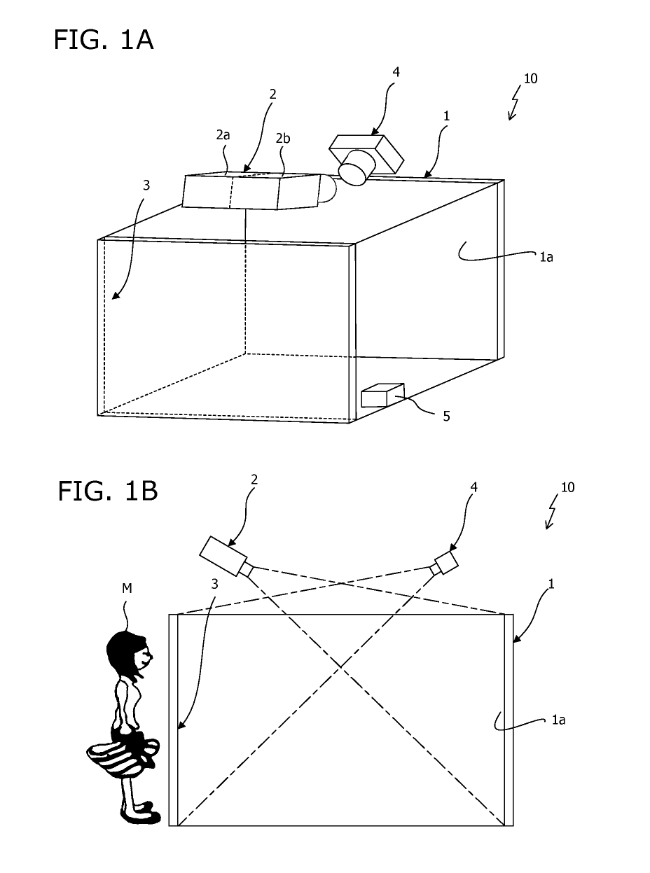

FIGS. 1A and 1B are diagrams showing a schematic configuration of a three-dimensional image display device 10 illustrated as a first embodiment of the present invention. FIG. 1A is a perspective view of the three-dimensional image display device 10, and FIG. 1B is a side view thereof.

The three-dimensional image display device 10 according to the present embodiment displays three-dimensional images using the polarization filter method and is composed of a screen 1, a projection device 2, a control panel 3, a camera 4, and a control device 5. Here, in the three-dimensional image display device 10 as illustrated, a three-dimensional image viewing device is composed of, for example, the control panel 3, the camera 4, and the control device 5.

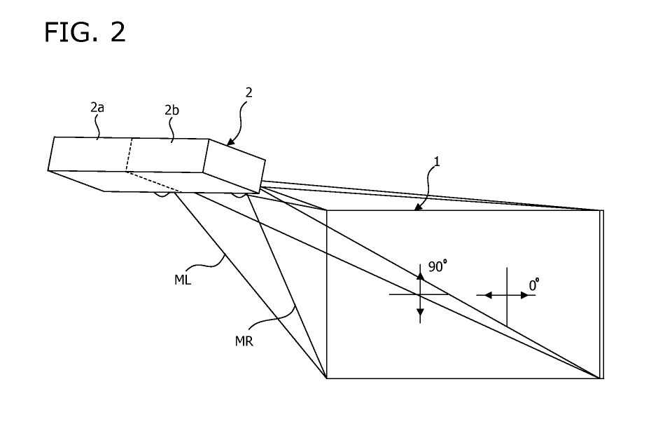

The projection device 2 is composed of a pair of left and right projectors 2a and 2b. As shown in FIG. 2, the left and right projectors 2a and 2b respectively project an image for the left eye and an image for the right eye (hereinafter simply referred to as left and right images, respectively) to the same region on the screen 1. These images utilize binocular parallax (a difference between left and right viewpoints) to realize 3D perception, and the projectors 2a and 2b use different polarized lights whose polarized axes (the direction of the oscillation of the light) cross each other at a right angle. Note that a surface 1a of the screen 1 is a display screen 1a of the left and right images.

According to the present embodiment, the projector 2a, the projector at left in FIG. 2, provides the image for the left eye on the screen 1, by projecting the left image light (first light) for the left eye, which is a linearly polarized light ML, whose polarization axis is set to the vertical direction or at an angle of 90 degrees, on the surface 1a of the screen 1. The projector 2b, the projector at right in FIG. 2, provides the image for the right eye on the screen 1, by projecting the right image light (second light) for the right eye, which is linearly polarized light MR, whose polarization axis is set to the horizontal direction or at an angle of 0 degree, on the surface 1a of the screen 1.

As shown in FIG. 1B, the control panel 3 is a generally transparent panel installed at a predetermined distance from the screen 1 so as to separate the screen 1 and a viewer M. The viewer M can see the left and right images projected on the screen 1 through the control panel 3.

The camera 4 is installed above the screen 1 and is on the plumb line crossing the center of one side in the left-right direction of the control panel 3. The camera 4 is a digital camera that shoots an object (viewer M) behind the control panel 3 through the control panel 3 and captures his/her image. The viewing angle of the camera 4 is wide enough to capture the entire control panel 3.

The control device 5 in FIG. 1A is electrically connected to the control panel 3 and to the camera 4 to control their operations.

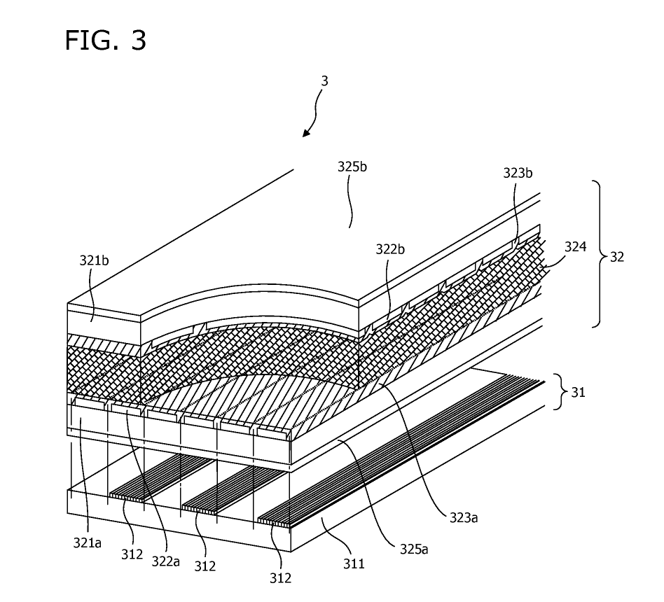

The control panel 3 is described in detail below. FIG. 3 is an enlarged perspective cutout view of the control panel 3, illustrating the structure of the control panel 3. The control panel 3 is composed of a polarization direction control element 31, which constitutes the back side of the control panel 3, the back side being the side facing the screen 1, and a liquid crystal element 32, which constitutes the front side of the control panel 3, the front side being the side facing the viewer M.

As for the polarization direction control element 31, retardation films 312 are disposed in a striped pattern on a transparent substrate 311, thereby dividing an entire region into many unit regions. These unit regions are explained below in detail.

The retardation film 312 is a one-half wavelength retardation film, which is designed to cause one-half wavelength retardation in the incoming visible light having a predetermined wavelength (550 nm, for example). The optical axis (retarded phase axis) of the retardation film 312 is set to an angle of 45 degrees to the incoming light. That is, the retardation film 312 can rotate the polarization axis of the polarized light entering the back side of the polarization direction control element 31, which are the left image light ML and the right image light MR that have been reflected at the screen 1.

In the following description, the left image light ML and the right image light MR that have been reflected at the screen 1 are simply referred to as the left image light ML and the right image light MR.

Additionally, regarding the polarization direction control element 31, the unit regions having the retardation film 312 are referred to as the direction conversion regions, whereas the other unit regions, which do not have the retardation film 312, are referred to as the non-direction conversion region. In the present embodiment, the direction conversion region is a second unit region of the present invention, and the non-direction conversion region is a first unit region of the present invention.

The liquid crystal element 32 is a passive TN (Twisted Nematic) liquid crystal element, which retardation is set to process the visible light having a predetermined wavelength (550 nm, for example). As shown in FIG. 3, the liquid crystal element 32 includes a first transparent substrate 321a disposed to face the polarization direction control element 31, and a second transparent substrate 321b disposed opposite to the first transparent substrate 321a.

The first transparent substrate 321a has, on the side facing the second transparent substrate 321b, a first transparent electrode 322a arranged in a striped pattern, and a first alignment film 323a, layered in this order. The second transparent substrate 321b has, on the side facing the first transparent substrate 321a, strips of a second transparent electrode 322b, the extending direction of which is perpendicular to the extending direction of the first transparent electrode 322a, and a second alignment film 323b, layered in this order. A liquid crystal layer 324 is interposed between the first transparent substrate 321a and the second transparent substrate 321b. The liquid crystal layer 324 is composed of nematic liquid crystal having a positive dielectric constant anisotropy and is aligned at a torsion angle of 90 degrees in the default setting. Here, although not shown in FIG. 3, driver elements that drive the nematic liquid crystals are disposed on either the first transparent substrate 321a or the second transparent substrate 322b using the COG (Chip On Glass) method. The driver elements are connected to lead wirings led out of the first transparent substrate 321a and to the second transparent electrode 322b. Additionally, the liquid crystal molecules are driven by the driver elements with a so-called simple matrix method.

A first polarizer 325a and a second polarizer 325b are respectively disposed on the outer surface of the first transparent substrate 321a, through which the image lights ML and MR enter, and on the outer surface of the second transparent substrate 321b from which the left and right image lights ML and MR exit.

The polarization transmission axis of the first polarizer 325a extends vertically (angle of inclination: 90 degrees), and the polarization transmission axis of the second polarizer 325b extends horizontally, i.e., 90 degrees away from the polarization transmission axis of the first polarizer 325a (angle of inclination: 0 degree). That is, the liquid crystal element 32 is a normally white mode device.

Regarding the liquid crystal element 32, the control region of the control panel 3 is composed of a liquid crystal cell (hereinafter simply referred to as “cell”). The cell is a region where the first transparent electrode 322a crosses the second transparent electrode 322b, and also is the driving unit of the nematic liquid crystal. That is, as for the control panel 3, a pixel is configured on a cell-by-cell basis.

Therefore, in the control panel 3, by controlling individual cells of the liquid crystal element 32 to enter either the driving mode or the non-driving mode, individual control region, as described below, can respectively enter the transmissive mode or the non-transmissive mode.

Here, the driving mode refers to a state in which a voltage that is high enough to align the liquid crystal molecules in the liquid crystal layer significantly differently from the default molecule orientation (ON voltage) is applied to the liquid crystal layer. The non-driving mode refers to a state in which a voltage that is low enough to maintain the default orientation of the liquid crystal molecules in the liquid crystal layer (OFF voltage) or zero voltage is applied to the liquid crystal layer.

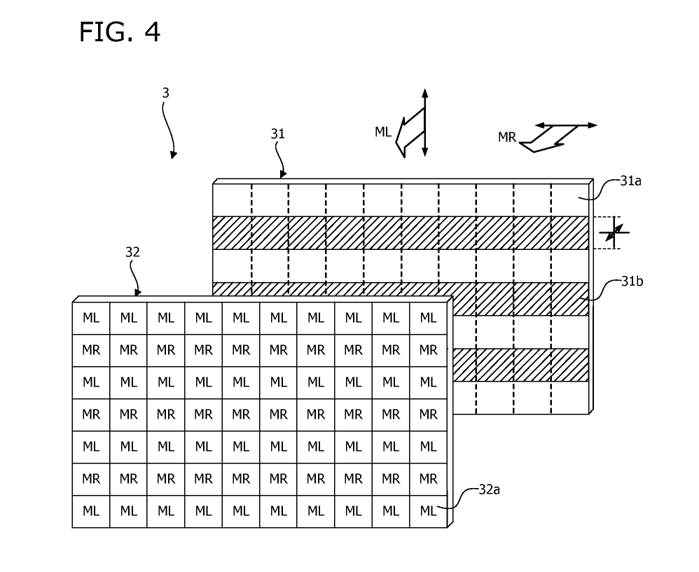

FIG. 4 is an exploded perspective view of the control panel 3 illustrating the unit regions of the polarization direction control element 31 and the cells 32a of the liquid crystal element 32. In the control panel 3, each of the regions that are divided into a matrix, and are respectively corresponding to the cells 32a of the liquid crystal element 32 is a control region.

Regarding the polarization direction control element 31, as shown in FIG. 4, a unit region is a horizontally-long region that corresponds to each row on the control panel 3, containing a plurality of control regions (the plurality of the cells 32a in the liquid crystal element 32). A strip of the retardation film 312 is disposed for every other rows of the unit regions. In other words, on the polarization direction control element 31, the non-direction conversion region 31a and the direction conversion region 31b alternate in the vertical direction.

In the following description, of all the control regions on the control panel 3, a control region corresponding to a non-direction conversion region of the polarization direction control element 31 is referred to as the first control region, and a control region corresponding to a direction conversion region of the polarization direction control element 31 is referred to as a second control region, to clarify the difference between the two types of control regions.

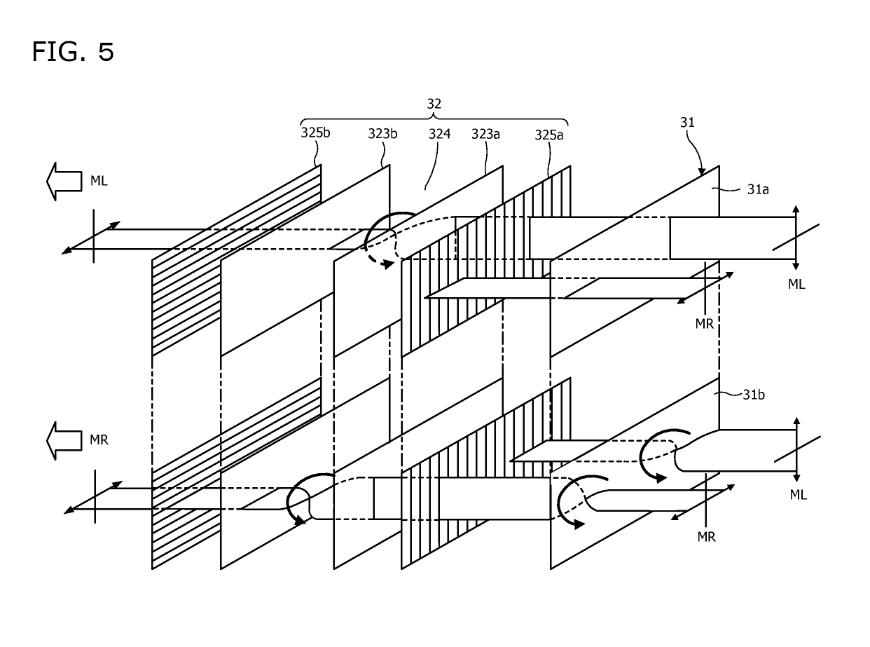

FIG. 5 is a view illustrating the optical effect of the control panel 3 when the liquid crystal element 32 (all of the cells 32a) is in the non-driving mode. As described above, the retardation films 312 are formed on the direction conversion regions 31b of the polarization direction control element 31. With the retardation film 312, polarization axes of the incoming left image light ML and the right image light MR are rotated by 90 degrees.

Therefore, the left image light ML and the right image light MR that have passed through the polarization direction control element 31 now have polarization axes with new inclination angles. That is, the left and right image lights ML and MR that have passed through the direction conversion region 31a now have polarization axes with inclination angles different, by 90 degrees, from those of the polarization axes of the left and right image lights ML and MR that have passed though the non-direction conversion region 31a.

More specifically, the polarization axis of the left image light ML that has passed through the direction conversion region 31b is rotated to an inclination angle of 0 degree, and the polarization axis of the left image light ML that has passed through the non-direction conversion region 31a is not rotated and maintains the same inclination angle of 90 degrees. Also, the polarization axis of the right image light MR that has passed though the direction conversion region 31b is rotated to an inclination angle of 90 degrees, and the right image light MR that has passed through the non-direction conversion region 31a is not rotated and maintains the same inclination angle of 0 degree.

The first polarizer 325a (polarizer disposed on the side of the light entry), which is a component of the liquid crystal element 32, has the same (in the vertical direction) polarization transmission axis for all the control regions. Therefore, of all the left and right image lights ML and MR that have passed through the non-direction conversion region of the polarization direction control element 31, only the left image light ML can pass through the liquid crystal element 32. That is, while the right image light MR is blocked by the first polarizer 325a, the left image light ML is transmitted through the first polarizer 325a. The left image light ML that has passed through the first polarizer 325a is then subjected to the polarization axis rotation as it passes through the liquid crystal layer 324 of the liquid crystal element 32, to an inclination angle of 0 degree, so that it can be transmitted through the second polarizer 325b (polarizer disposed on the side from which the light exits).

On the contrary, of the left and right image lights ML and MR that have passed through the direction conversion region 31b of the polarization direction control element 31, only the right image light MR can be transmitted through the liquid crystal element 32. That is, while the left image light ML is blocked by the first polarizer 325a, the right image light MR is transmitted through the first polarizer 325a. The right image light MR that has passed through the first polarizer 325a is then subjected to the polarization axis rotation as it passes through the liquid crystal layer 324 of the liquid crystal element 32, to an inclination angle of 0 degree, so that it can be transmitted through the second polarizer 325b.

Cells 32a denoted as “ML” in FIG. 4 are the cells 32a that transmits only the left image light ML in the non-driving mode, and cells 32a denoted as “MR” in FIG. 4 are the cells 32a that transmits only the right image light MR in the non-driving mode.

In other words, in the control panel 3, when the liquid crystal element 32 (all of the cells 32a) is in the non-driving mode, only the left image light ML can be transmitted through the first control region corresponding to the non-direction conversion region 31a of the polarization direction control element 31. On the other hand, only the right image light MR can be transmitted through the second control region corresponding to the direction conversion region 31b of the polarization direction control element 31.

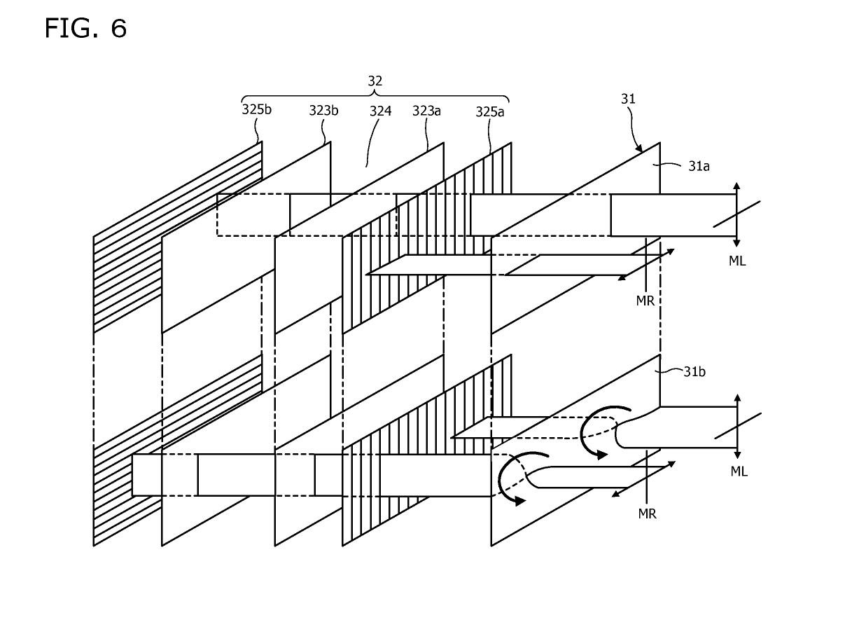

FIG. 6 is a view illustrating the optical effect of the control panel 3 when the liquid crystal element 32 (all of the cells 32a) is in the driving mode. When the liquid crystal element 32 is in the driving mode, light entering the liquid crystal layer 324 proceeds straight to the second polarizer 325b, maintaining the same inclination angle of the polarization axis. Therefore, both the left image light ML that has passed through the non-direction conversion region 31a of the polarization direction control element 31 and the right image light MR that has passed though the direction conversion region 31b of the polarization direction control element 31 are blocked by the second polarizer 325b.

In other words, in the control panel 3, when the liquid crystal element 32 is in the driving mode, the left and right image lights ML and MR cannot pass through either the first and second control regions due to the optical shutter function of the liquid crystal element 32.

Therefore, in the control panel 3, by selectively driving the cells 32a of the liquid crystal element 32 on a cell-by-cell basis, with respect to any given particular region in the liquid crystal element 32, only one of the left image light ML and the right image light MR, whichever selected, can be allowed to pass through that particular region. In other words, by driving all the cells 32a in the first control region of that particular region, only the right image light MR can pass through that particular region. Also, by diving all the cells 32a in the second control region of that one particular region, only the left image light LR can pass through that particular region.

As described above, in the control panel 3, pixels that are not provided with the retardation film 312 (the first pixels) are configured to be switchable between a first state in which both the image light ML for the left eye and the image light MR for the right eye are blocked by the first pixels and a second state in which the image light ML is transmitted, but the image light MR is blocked by the first pixels. Therefore, the first pixels, pixels for which the retardation film 312 is not provided, are provided for processing the left eye image light ML. Furthermore, pixels that are provided with the retardation film 312 (the second pixels) are configured to be switchable between the aforementioned first state (i.e., both ML and MR are blocked by the second pixels) and a third state in which the image light MR is transmitted, but the image light ML is blocked by the second pixels. Therefore, the second pixels, for which the retardation film 312 is provided, are provided for processing the right eye image light MR.

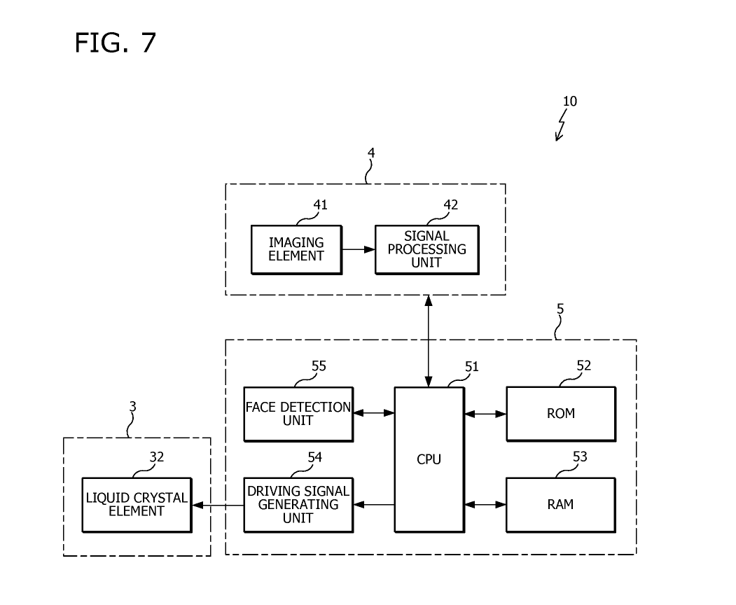

Next, an electrical configuration of the three-dimensional image display device 10 is described below. FIG. 7 is a schematic block diagram illustrating an electrical configuration of main parts of the three-dimensional image display device 10. In the three-dimensional image display device 10, as previously described, the control panel 3 and the camera 4 are electrically connected to the control device 5.

The camera 4 is mainly composed of an imaging element 41 and a signal processing unit 42. The imaging element 41 is a CCD (Charge Coupled Device)-type or MOS (Complementary Metal Oxide Semiconductor)-type imaging element, for example. The imaging element 41 converts an optical image of an object, which is formed on the imaging surface (photosensitive surface) by an imaging lens (not shown) of the camera 4, into electrical signals by photoelectric conversion, and sends the converted electrical signals—i.e., the imaging signals—to the signal processing unit 42.

The signal processing unit 42 includes an AFE (Analog Front End), which is composed of a CDS (Correlated Double Sampling) for converting the image signals sent from the imaging element 41 to digital signals, a PGA (Programmable Gain Amp), and an ADC (Analog-to-Digital Convertor); and also a DSP (Digital Signal Processor), which performs a predetermined digital signal processing to the imaging signals that have been converted to the digital signals.

The camera 4 functions as an image capturing means of the present invention by supplying the imaging signals digitized by the signal processing unit 42, that is, the acquired image data, to the control device 5.

The control device 5 is mainly composed of a CPU (Central Processing Unit) 51, a ROM (Read Only Memory) 52, a RAM (Random Access Memory) 53, a driving signal generating unit 54, and a face detection unit 55.

The ROM 52 is a memory for storing control programs and the like used by CPU 51 to control the operations of the camera 4 and the liquid crystal element 32. The RAM 53 is an external memory for storing various data as needed when CPU 51 controls the operations of the camera 4 and the liquid crystal element 32.

CPU 51 operates according to the control program stored in the ROM 52 to control the camera 4 and the operation of the liquid crystal element 32 of the control panel 3. CPU 51 is a component of the position identifying unit and the control circuit of the present invention.

The driving signal generating unit 54 generates driving signals for driving individual cells of the liquid crystal element 32 of the control panel 3 in accordance with the driving control data sent from CPU 51, and sends the driving signals to the liquid crystal element 32.

The face detection unit 55, at the instruction of CPU 51, performs the face detection processing on the image data provided by the camera 4 to the control device 5 (CPU 51). The face detection processing includes the detection of a face region within the acquired image, which is a specific region having characteristics close to the characteristics of the predetermined (pre-stored) model pattern of a human face, such as facial contour and color. The face detection processing includes image binarization, contour extraction, pattern matching, and other image processing.

The face detection unit 55 is composed of image processing circuits for various image processing necessary for the face detection processing, a plurality of registers for storing parameters, working memory, and the like.

The face detection unit 55 functions as the face detection means of the present invention, by supplying CPU 51 with the coordinate information of the face region detected in the face detection process, as well as the position information of both eyes of a person in the detected face region. Also, according to the present embodiment, CPU 51 and the face detection unit 55 together constitute a viewer detection means of the present invention.

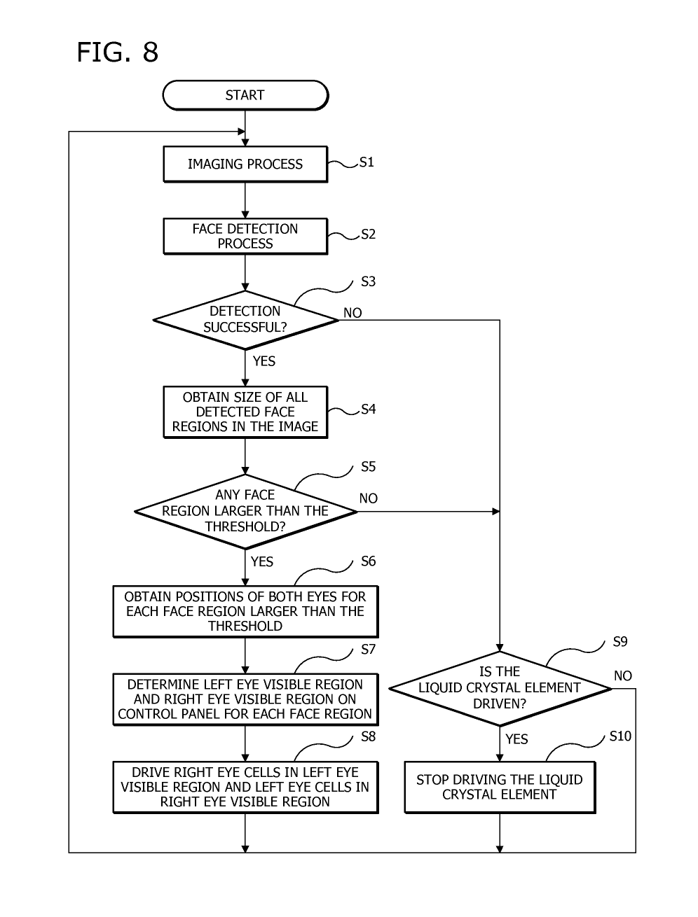

In the three-dimensional image display device 10, which is configured as described above, while the projection device 2 projects a three-dimensional image (left and right images) on the screen 1, CPU 51 controls the control panel 3 as described below in accordance with the control program stored in ROM 52. FIG. 8 is a flowchart showing the control process for the control panel 3 performed by CPU 51.

As shown in FIG. 8, CPU 51 starts its operation when the control device 5 is turned on, for example; immediately controls the camera 4 to perform the image capturing; and perform image processing to obtain data of the acquired image (step S1). CPU 511 stores the obtained data (image data) in RAM 53.

The image acquired by the camera 4 in step S1 is the image of an object that is situated outside the control panel 3, and is acquired through the control panel 3. This image covers the entire region of the control panel 3. Since the camera 4 is installed above the screen 1, the image acquired by the camera 4 is in a trapezoid shape in which the upper side is longer than a lower side.

Next, CPU 51 performs the face detection process (step S2). Specifically, CPU 51 supplies the acquired image data received from the camera 4 to the face detection unit 55, which detects any face region from the acquired image.

Next, CPU 51 checks whether or not the face detection unit 55 has detected one or more face regions (step S3). If no face region is detected (step S3: NO), CPU 51 further checks whether or not the liquid crystal element 32 is being driven, that is, whether or not any cells of the liquid crystal element 32 are being driven (step S9).

If the liquid crystal element 32 is being driven (step S9: YES), CPU 51 stops the driving of the liquid crystal element 32 (step S10) and returns to Step S1. If the liquid crystal element 32 is not being driven, CPU 51 immediately returns to the step S1 and obtains a new image.

At the beginning of the processing, the liquid crystal element 32 is in the non-driving state. If no face region is detected, CPU 51 immediately returns to the step S1 and obtains a new image. Subsequently, CPU 51 repeats the processes of step S1 and step S2 until a face region is detected in the acquired image.

Subsequently, once one or more face regions are detected in the acquired image (step S3: YES), CPU 51 first obtains the sizes of the detected face regions within the acquired image (step S4).

Next, CPU 51 checks whether or not there exist one or more face regions whose size is larger than a predetermined threshold value (step S5). The threshold value of the face region is set to correspond to the size of the face region of a viewer having the standard size face who is located at a predetermined distance (15 cm, for example) from the control panel 3.

Specifically, in step S5, CPU 51 preliminarily determines whether any faces in the acquired image are considered within the predetermined distance from the control panel 3 using the detected size of the face regions.

That is, CPU 51 uses the size of the face region as distance information determining the distance between the face of a person in the acquired image and the control panel 3 and, based on this information, determines if any viewer is present within the predetermined distance from the control panel 3.

If no face region has an area larger than the threshold value, that is, if all the faces in the acquired image are away from the control panel 3 beyond the predetermined distance (step S5: NO), CPU 51 checks if the liquid crystal element 32 is being driven (step S9). If the liquid crystal element 32 is not being driven (as in the case of the beginning of the processing (step S9: NO)), CPU 51 goes to the step S10 process, which is described above.

If any face region larger than the threshold value is detected in the acquired image, that is, if any human face is present within the predetermined distance from the control panel 3 (step S5: YES), CPU 51 performs the next processes described below.

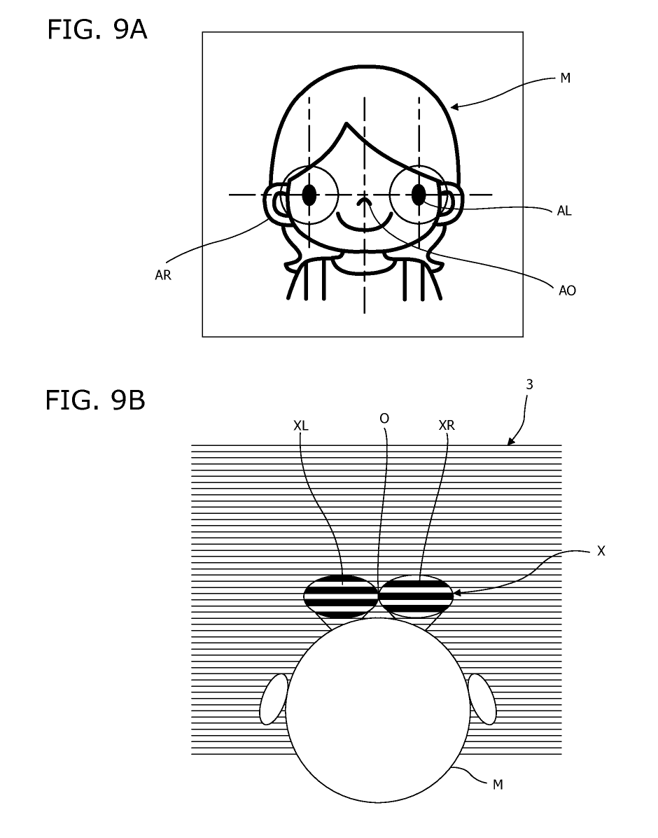

First, CPU 51 performs image binarization, contour extraction, pattern matching, and other image processing on the image data of the face region stored in the RAM 53. For each face region larger than the threshold value, CPU 51 obtains the coordinate positions of the left eye and the right eye (hereinafter referred to as “positions of both eyes”) within the acquired image. FIG. 9A is a diagram illustrating the positions of both eyes AL and AR of a person who is present in the acquired image, that is, the viewer M looking at the three-dimensional image.

Next, based on the obtained coordinate data on the positions of both eyes AL and AR, CPU 51 determines a left eye visible region and a right eye visible region on the control panel 3 for each face region (step S7). Here, the left eye visible region is a specific region of the control panel 3 that is included in the field of view of the left eye of the viewer M to whom the face region corresponds. Similarly, the right eye visible region is a specific region of the control panel 3 that is included in the field of view of the right eye of the viewer M to whom the face region corresponds. FIG. 9B is a diagram showing the left eye visible region XL and the right eye visible region XR on the control panel 3 when the control panel 3 is viewed from the outside (viewer's side).

CPU 51 determines the left eye visible region XL and the right eye visible region XR in accordance with a specific procedure as follows. That is, during the processing of step S7, CPU 51 first obtains the coordinate position of the midpoint AO of the straight line connecting the left eye position AL and the right eye position AR of the viewer M in the acquired image (see FIG. 9A). Next, CPU 51 calculates the coordinate position of the intersection O on the control panel 3, where the intersection O is the point where a hypothetical line, which is passing through the midpoint AO and is normal to the surface of the control panel 3, intersects with the surface of the control panel 3, for example.

Next, CPU 51 identifies two circles disposed side by side, left and right, having a predetermined diameter and contacting each other at the intersection O where the calculated hypothetical line and the surface of the control panel 3 meet. Here, the size (diameter) of the two left and right circles is determined in accordance with the threshold value of the face region size used in step S5, that is, the size determined based on the predetermined distance.

Next, CPU 51 determines a region bounded by the left circle positioned to the left of the control panel 3 to be the left eye visible region XL, and a region bounded by the right circle positioned to the right of the control panel 3 to be the right eye visible region XR (see FIG. 9B). More specifically, CPU 51 specifies the plurality of control regions of the control panel 3 which are located in the left eye visible region XL, and the plurality of control regions on the control panel 3 which are located in the right eye visible region XR.

Now, it should be noted that the image acquired by the camera 4 is an image taken from above the screen 1, as previously described. This means that the control panel 3 in the acquired image has a trapezoidal shape, in which the upper side is longer than the lower side. Therefore, in the step S7 process, CPU 51 takes into consideration the position of the camera 4 when calculating the coordinate position of the intersection O where the hypothetical line intersects with the surface of the control panel 3, the hypothetical line passing through the midpoint AO of the straight line connecting the left and right eye positions AL and AR of the viewer, and being normal to the surface of the control panel 3.

For example, CPU 51 calculates a coordinate position of the intersection O in a coordinate space of the acquired image by using a predetermined function calculation based on the known values of the horizontal distance between the control panel 3 and the camera 4, the vertical shooting angle of the camera 4, and the aforementioned predetermined distance using a coordinate position of the midpoint AO as a parameter. Then, CPU 51 converts the calculated coordinate position of the intersection O into a coordinate position in the real space, i.e., a coordinate position on the surface of the control panel 3, to obtain the converted coordinate position, which is the final coordinate position of the intersection O.

After determining the left eye visible region XL and the right eye visible region XR, CPU 51 controls the driving signal generating unit 54 to generate prescribed driving signals and to send the generated driving signals to the liquid crystal element 32, to drive a cell group of the liquid crystal element 32 for the right eye, located in the left eye visible region XL, and a cell group for the left eye, located in the right eye visible region XR (step S8).

Here, among all the cells 32a of the liquid crystal element 32, the cell group for the left eye is a plurality of cells 32a of the control panel 3, which constitute the first control region that transmits only the left image light ML (cells marked as “ML” in FIG. 4), and the cell group for the right eye is the plurality of cells 32a of the control panel 3, which constitute the second control region that transmits only the right image light MR (cells marked as “MR” in FIG. 4).

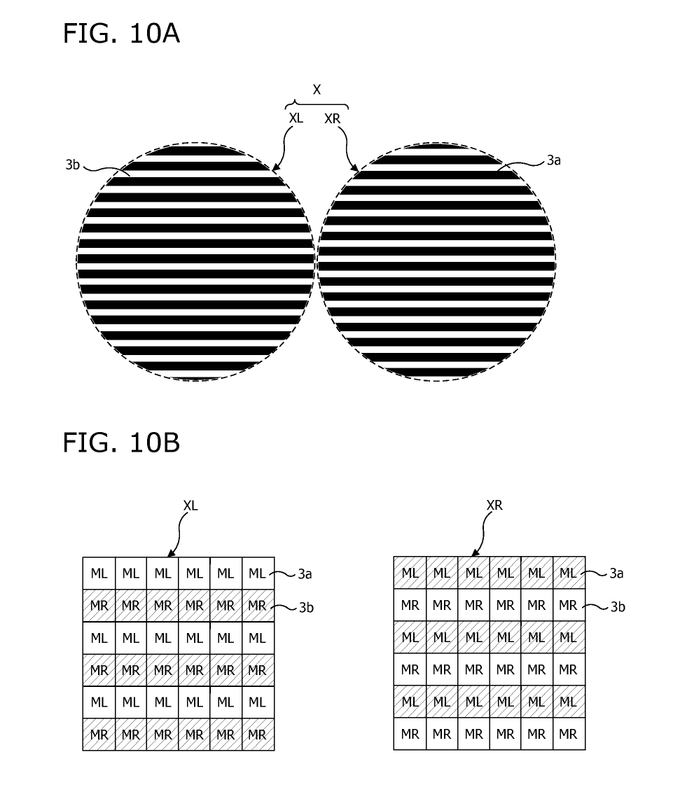

As a result, in the control panel 3, as shown in FIG. 10A, only the plurality of second control regions 3b in the left eye visible region XL, disposed in every other horizontal row, block light (black display). Conversely, in the right eye visible region XR, only the plurality of first control regions 3b disposed in every other horizontal row block light (black display).

FIG. 10B is a partially-enlarged view of the left eye visible region XL and the right eye visible region XR. A diagram on the left is a partially-enlarged view of the left eye visible region XL, and a diagram on the right is a partially-enlarged view of the right eye visible region XR. In the figure, shadowed regions (the first control region 3a or the second control region 3b) are in the non-transmissive mode. Note that FIGS. 10A and 10B are diagrams when the control panel 3 is viewed from outside (viewer's side).

Specifically, in the step S8 process, a polarized glasses unit X, which is essentially 3D glasses used in conventional technologies for viewing three-dimensional images, composed of the left eye visible region XL and the right eye visible region XR, is automatically formed on the control panel 3 in a position corresponding to the positions of the eyes of the viewer M.

As a result, the viewer M in front of the control panel 3 can view the left eye image projected on the screen 1 only with the left eye through the left eye visible region XL, and, at the same time, can view the right eye image projected on the screen 1 only with the right eye through the right eye visible region XR.

Also, when there is more than one face region in the acquired image having a size larger than the threshold value, CPU 51 performs the processes of steps S6 to S8 described above for each of such face regions. Therefore, when a plurality of viewers are present nearby the control panel 3, a polarized glasses unit X is generated for each one of such viewers in the step S8 process on the control panel 3 at different locations corresponding to the positions of both eyes of the respective viewers.

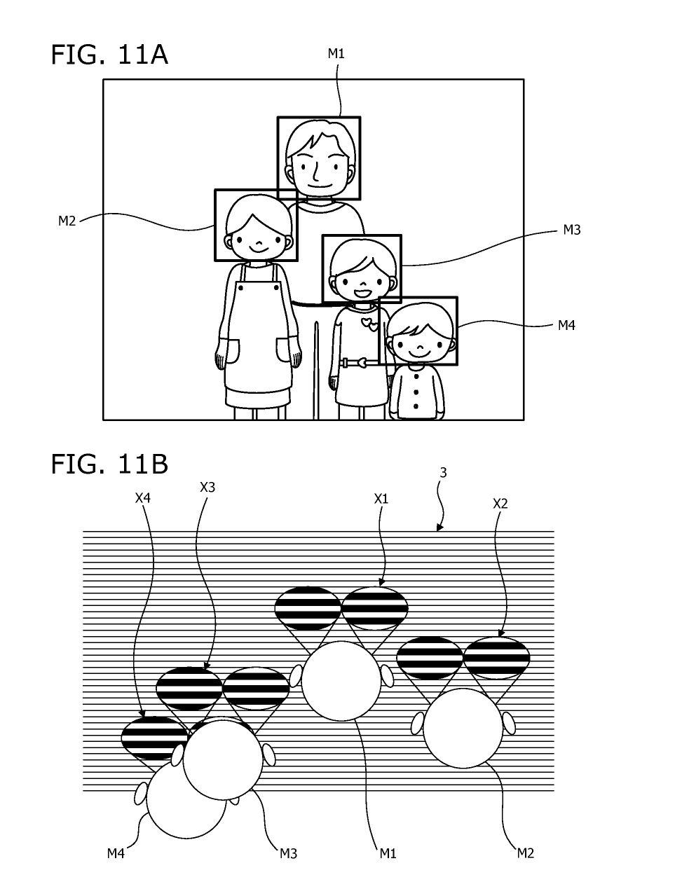

FIGS. 11A and 11B, which correspond to FIGS. 9A and 9B respectively, illustrate a case in which four viewers M1 to M4 are present near the control panel 3. When the four viewers M1 to M4 are present near the control panel 3, as shown in FIG. 11A, polarized glasses units X1 to X4 are generated on the control panel 3 for the viewers M1 to M4 at respective locations corresponding to viewers M1 to M4.

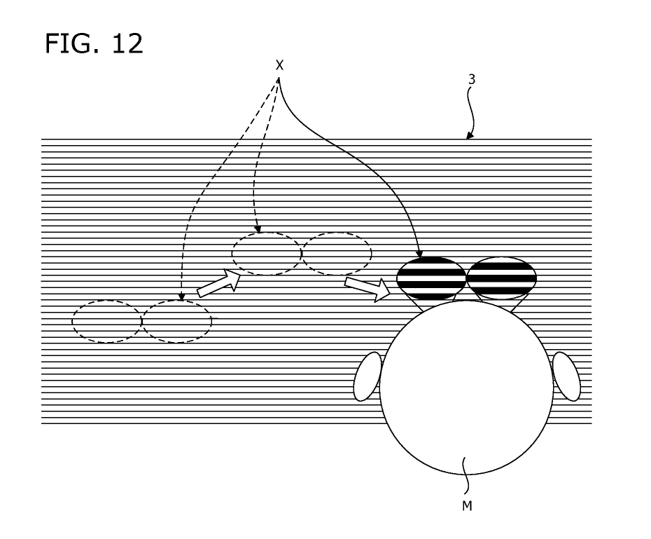

Next, CPU 51 returns to the step S1 process to obtain data for a new acquired image, and then repeats the step S2 process and the subsequent steps. Therefore, if the face of viewer M (positions of both eyes) moves up and down, left and right, while a polarized glasses unit X is being generated on the control panel 3, the position of the polarized glasses unit X generated on the control panel 3 also moves following the movement of the face (positions of both eyes) of viewer M, as shown in FIG. 12.

Also, if a viewer moves outside the angle of view of the camera 4 while a polarized glasses unit X is generated on the control panel 3, and consequently the face region cannot be detected within the acquired image anymore (step S3: NO), CPU 51 stops the driving of the liquid crystal element 32 (step S10). That is, CPU 51 eliminates the corresponding polarized glasses unit X that has been generated on the control panel 3 up to that point in time.

Also, when a viewer moves away from the control panel 3 while a polarized glasses unit X is generated on the control panel 3, and consequently the size of the face region detected from the acquired image becomes smaller than the threshold value (step S5: NO), CPU 51 stops the driving of the liquid crystal element 32 (step S10). That is, CPU 51 eliminates the polarized glasses unit X that has been generated on the control panel 3 up to that point in time.

As described above, in the three-dimensional image display device according to the present embodiment, a polarized glasses unit X is automatically generated on a particular location of the control panel 3, which is a pair of regions corresponding to the positions of both eyes of a viewer who is present within a predetermined distance from the control panel 3. Further, the location on the control panel 3 at which the polarized glasses unit X is generated follows the movement of both eyes of the viewer's face. This means that a viewer who is not wearing polarized glasses can view three-dimensional images by way of the polarization filter method without being at a particular viewing position.

Further, according to the present embodiment, the general area—i.e., the area of the control panel 3 where polarized glasses units X are not formed—is transparent, and therefore, the left and right image lights ML and MR for the left and right images are transmitted through each of the control regions (first control region 3a and second control region 3b).

Therefore, an arbitrary number of people other than viewers M who are present within a predetermined distance from the control panel 3 can view image contents displayed on the surface (display screen) of the screen 1 as a two-dimensional original image, albeit with some difficulties. Furthermore, when product samples and the like are arranged between the screen 1 and the control panel 3, such an arbitrary number of people other than viewers M can also view the product samples and the like through the control panel 3 without a problem. As a result, the image content can attract attention of those people who are away from the control panel 3 beyond the predetermined distance.

Also, with the three-dimensional image display device according to the present embodiment, a polarized glasses unit X is generated on the control panel 3 only when a person is present within the predetermined distance from the control panel 3 and is recognized as a viewer. Therefore, it is possible to provide three-dimensional images only to a person who approaches the control panel 3 and enters the zone within the predetermined distance.

### (Modifications)

Modifications of the above-described embodiment are described as follows. The process to determine the left eye visible region XL and the right eye visible region XR described in the above embodiment is only an example. Any appropriately designed process may be used to determine the left eye visible region XL and the right eye visible region XR in the practice of the present invention.

Also, in the present embodiment, the left eye visible region XL and the right eye visible region XR (hereinafter referred to as the “left and right visible regions XL and XR”) are configured to be two circular regions, which are arranged side by side and contacting each other, each having a predetermined size. However, the size, shape, and positional relationship of the left and right visible regions XL and XR are changeable as needed.

For example, the size of the left and right visible regions XL and XR can be changed in accordance with the distance between the control panel 3 and a viewer's face, by determining the distance more precisely than in the case of the above embodiment. That is, the left and right visible regions XL and XR can be made smaller as the distance between the control panel 3 and the viewer's face becomes shorter, and the size thereof can be made larger as the distance therebetween becomes longer.

Additionally, the shape of the left and right visible regions XL and XR may be other than circles and can be ovals or polygons, for example. Also, the left and right visible regions XL and XR do not necessarily have to be in contact with each other, and may be apart from each other.

Additionally, the general area, i.e., the area of the control panel 3 where polarized glasses units X are not formed, is transparent in the above embodiment. However, the general area may be non-transparent (black display). To make the general area of the control panel 3 non-transparent (black display), all of the corresponding cells 32a of the liquid crystal element 32 should be in the driving mode. Then, when generating a polarized glasses unit X, in the left eye visible region XL, only the cell group for right eye should be in the driving mode, and in the right eye visible region XR, only the cell group for left eye should be in the driving mode.

Also, in the above embodiment, all of the first control regions 3a and the second control regions 3b in the general area of the control panel 3, which is the area where polarized glasses units X are not generated, are made transmissive, and therefore the general area is transparent. Alternatively, the general area of the control panel 3 may be made transparent by making transmissive only one of the first control regions 3a and the second control regions 3b.

When the general area of the control panel 3 is made transparent by making transmissive only one of the first control regions 3a and the second control regions 3b, an arbitrary number of people other than viewers M (that is, people situated outside the predetermined range of the distance from control panel 3) can clearly see the two-dimensional original image, which is either the left image or the right image displayed on the surface of the screen 1. Also, as in the above embodiment, when product samples and the like are arranged between the screen 1 and the control panel 3, those people outside the range can also see the product samples and the like through the control panel 3 without a problem.

Also, according to the above embodiment, the presence or absence of a viewer within a predetermined distance from the control panel 3 is constantly monitored. Alternatively, the presence or absence of a viewer may be detected at a predetermined time interval. When the presence or absence of a viewer is detected at a predetermined time interval, a polarized glasses unit X generated on the control panel 3 may be maintained at the same position until the next detection of the presence or absence of a viewer occurs, or may be eliminated after a certain period of time has passed before the next detection of the presence or absence of the viewer.

Also, according to the above embodiment, the first control regions and the second control regions of the control panel 3 are alternately arranged in rows in the vertical direction. That is, the non-direction conversion regions 31a and the direction conversion regions 31b are alternately arranged in rows in the vertical direction.

However, the arrangement pattern of the first control regions and the second control regions in the control panel 3 may be changed as needed. For example, the first control regions and the second control regions can be arranged in columns in the horizontal direction, or may be arranged in a checkered pattern. Here, as for the arrangement pattern, the first control regions and the second control regions are more preferably aligned alternately in one direction.

Also, in the description of the above embodiment, the polarization direction control element 31 is explained to be composed of the transparent substrate 311, on which the retardation film 312 is formed in a striped pattern to provide unit regions, i.e. the non-direction conversion region 31a and the direction conversion region 31b (see FIG. 4).

However, the direction conversion region 31b of the polarization direction control element 31 may be made of other optical materials (such as birefringent crystal) having functions similar to the retardation film 312. Also, for the non-direction conversion region 31a of the polarization direction control element 31, a retardation film having an optical axis inclination angle relative to the incoming light that is 90 degrees different from that of the retardation film 312 may additionally be formed.

Also, in the description of the above embodiment, the liquid crystal element 32 driven by the simple matrix method is discussed. However, the liquid crystal element 32 may be substituted with the one in which each cell is provided with an active element such as a thin film transistor and is driven by the active matrix method.

Also, in the description of the above embodiment, the liquid crystal element 32 of normally white mode is discussed. However, the liquid crystal element 32 may be substituted with the one in the normally black mode. In such a case, if the entire general area (a region where the polarized glasses units X are not generated) of the control panel 3 is to be made non-transparent (black display), the power consumption of the control panel 3 can be significantly reduced.

When a liquid crystal element of normally black mode is used and the entire general area of the control panel 3 is made non-transparent (black display), the camera 4 is arranged outside the control panel 3, for example.

Also, according to the above embodiment, the presence or absence of a viewer within a predetermined distance range from the control panel 3 is detected based on the size of a face region in the image acquired by the camera 4, which is used as a guide to measure the distance between the viewer's face and the control panel 3.

Other methods may be used to detect the presence or absence of a viewer within a predetermined distance range from the control panel 3. For example, the presence or absence of a viewer within the predetermined distance range may be judged by installing one or more of human sensors that utilize, for example, infrared rays, ultrasonic waves, and/or visible light, and by setting the human detection range of the human sensor to be within a predetermined distance range from the control panel 3.

Also, by installing a plurality of range sensors on the front side of the control panel 3 for multiple point detection of the distances to a person or the like located close to the front side of the control panel 3, the presence or absence of a viewer within the predetermined distance range can be detected based on the detection result of each of the range sensors.

Also, the camera 4, which is a component of the three-dimensional image display device, does not need to be the one designed exclusively for three-dimensional image display devices. In other words, any existing camera model that has been used for any other purposes may be used as the camera 4 as long as such a camera is capable of capturing an image that can be used to identify the relative positions of both eyes of a viewer to the control panel 3. Further, when such an existing camera model is used, it may be installed outside the control panel 3.

Also, the camera 4 may be the one that captures moving images instead of still images. With camera 4 for capturing moving images, CPU 51 performs processes including a face detection using, for example, a frame of image selected at a predetermined timing from moving images sequentially acquired by the camera 4.

Further, the image used by CPU 51 for processes including the face detection does not have to be a single image acquired by a single camera, but may be a plurality of images captured by a plurality of cameras. However, when a plurality of captured images are used for processing such as face detection, all of the plurality of cameras need to be installed in positions from which all of the objects facing the control panel 3 can be included in one image.

Also, in the description of the above embodiment, a three-dimensional image display device is discussed, in which the left and right images that will be seen as a three-dimensional image by a viewer are projected to the screen 1 by the projection device 2 (a pair of left and right projectors 2a and 2b). The three-dimensional image viewing device of the present invention may be used for a direct view three-dimensional image display device, as will be explained next.

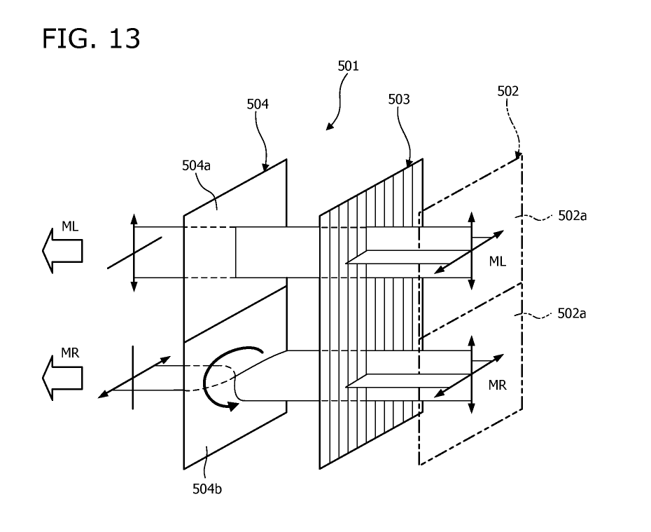

FIG. 13 is an illustration of one example of a display device used for a direct view three-dimensional image display device. It is an exploded perspective view schematically showing the configuration of main parts of a display device 501. The display device 501 is composed of a display element 502, and a polarizer 503 and a polarization direction control element 504, which are sequentially arranged on the front side of the display element 502.

The display element 502 is, for example, an EL (Electro Luminescence) element, a plasma element, a liquid crystal element or the like having a dot matrix structure. In the display element 502, a left eye image and a right eye image are displayed on every other pixel of pixels 502a that are arranged in a matrix.

The polarizer 503 has a polarization transmission axis that is in vertical direction (at an inclination angle of 90 degrees), as shown in FIG. 13, for example. The polarizer 503 only transmits polarization components in the left eye image light ML or in the right eye image light MR emitted by each pixel that have a 90-degree polarization axis.

The polarization direction control element 504 has a plurality of unit regions that are arranged to create one-to-one relationship with the respective pixels of the display element 502, and each of the unit regions is composed of non-direction conversion region 504a and direction conversion region 504b that are alternately arranged in a predetermined arrangement pattern in one direction (the vertical direction in the figure).

Both the non-direction conversion region 504a and the direction conversion region 504b have the same functions as those provided in the polarization direction control unit 31, as described with reference to the above embodiment. Specifically, the non-direction conversion region 504a transmits incoming polarized light (left eye image light ML in the figure) without change, and the direction conversion region 504b rotates the polarization axis of incoming polarized light (right eye image light MR in the figure) by 90 degrees.

Therefore, in the display device 501, the left eye image light ML and the right eye image light MR are displayed for every other pixel on a display screen constituted with the polarization direction control element 504, and the left and right image lights ML and MR have respective polarization axes that cross each other at a right angle.

By applying the three-dimensional image viewing device of the present invention to a direct view three-dimensional image display device that includes the display device 501 shown in FIG. 13, a viewer who does not wear polarized glasses can see a three-dimensional image displayed by the polarization filter method without being at a specified position.

Although a three-dimensional image display device using the polarized filter method is described above, the control panel 3 explained in the description of the above embodiments may also be applied to a three-dimensional image display device utilizing a time-division method. The time-division method is a method in which the left and right images (image for left eye and image for right eye) are displayed on a display screen in a time-division manner (at a predetermined frequency).

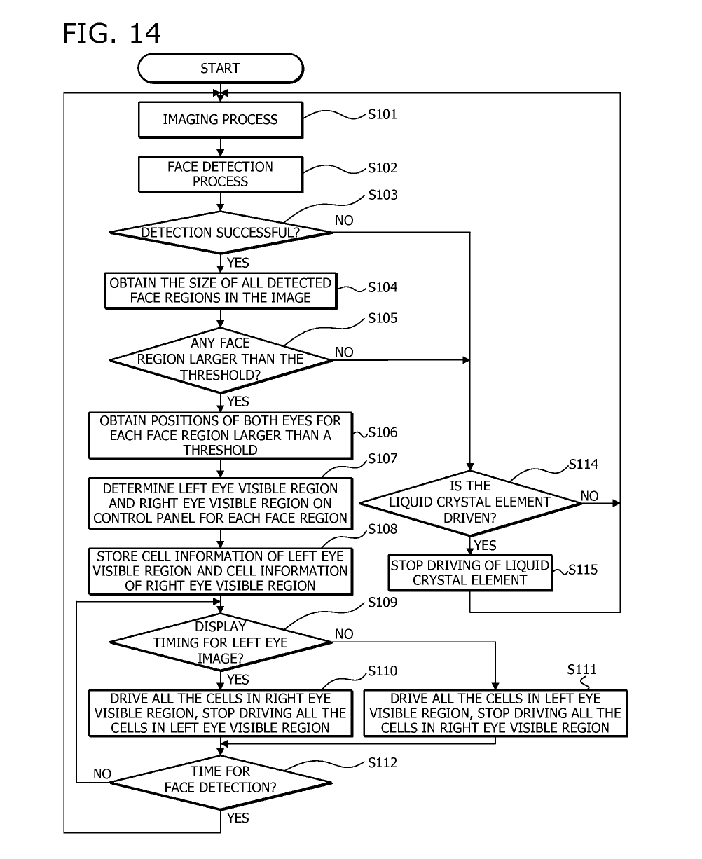

When the control panel 3 is used for a time-division three-dimensional image display device, the following structure may be employed, for example. First, in addition to the configuration shown in FIG. 7 a display device (including a projection device) that displays left and right images is electrically connected to CPU 51 via either a wired or wireless connection, for example. Also, the display device supplies timing signals indicating the timings at which the left and right images are alternately displayed to CPU 51. Also, ROM 52 stores a control program that controls CPU 51 to perform the processes shown in FIG. 14 while the display device is displaying a three-dimensional image (left and right images).

The processes performed by CPU 51 shown in FIG. 14 are described below. Steps S101 through S107 are the same as the steps S1 through S7 shown in FIG. 8. Specifically, when a viewer is present within a predetermined distance range from the control panel 3, CPU 51 determines a left eye visible region XL and a right eye visible region XR on the control panel 3 for each viewer (for each face region) (step S107).

Additionally, in an internal memory, CPU 51 stores cell information on all the cells of the liquid crystal element 32 located in the determined left eye visible region XL and also cell information on all the cells of the liquid crystal element 32 located in the determined right eye visible region XR (step S108). Then, CPU 51 checks whether or not the display timing controlled by the timing signal provided by the display device at the moment is for the left eye image (step S109).

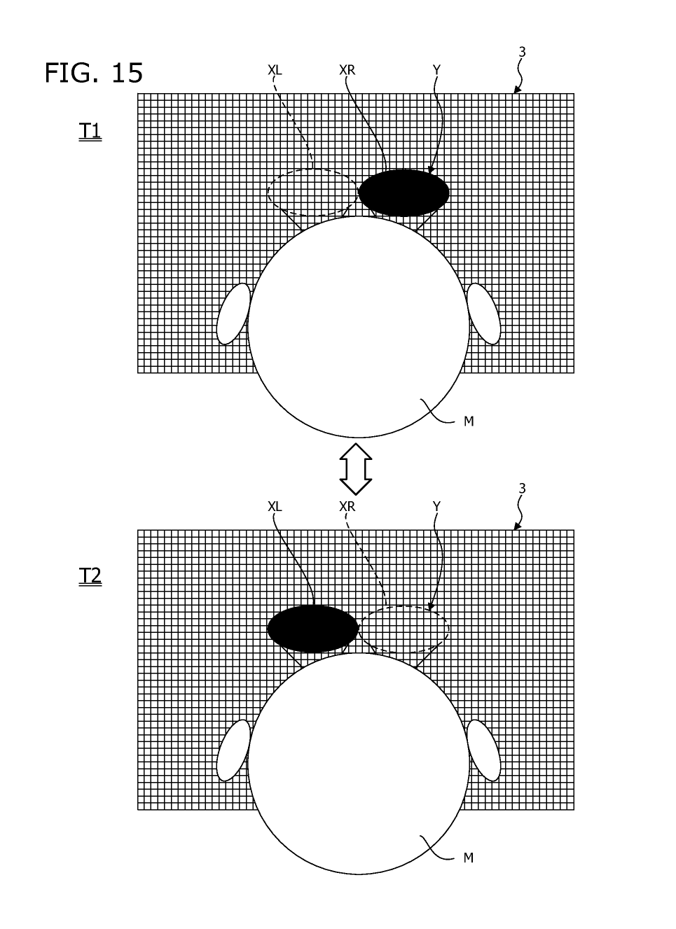

When the display timing is for the left eye image (step S109: YES), CPU 51 drives all the cells of the liquid crystal element 32 located in the right eye visible region XR, and stops the driving of all the cells of the liquid crystal element 32 located in the left eye visible region XL (step S110). Here, at the beginning of the processing, since all the cells of the liquid crystal element 32 are in the non-driving mode, CPU 51 simply drives all the cells of the liquid crystal element 32 located in the right eye visible region XR in the step S110 process. In the step S110 process, the entire left eye visible region XL on the control panel 3 is controlled to become transmissive, while the entire right eye visible region XR, conversely, is controlled to become non-transmissive (black display), as shown in FIG. 15 T1.

Next, until the face detection timing arrives after a predetermined interval (step S112: NO), CPU 51 checks whether or not the display timing is for the left eye image (step S109). When the display timing switches for the right eye image (step S109: NO), CPU 51 drives all the cells of the liquid crystal element 32 in the left eye visible region XL and stops the driving of all the cells of the liquid crystal element 32 in the right eye visible region XR (step S111).

In the step S111 process, the entire left eye visible region XL is controlled to become non-transmissive (black display), and the entire right eye visible region XR, conversely, is controlled to become transmissive, as shown in Timing T2 in FIG. 15.

CPU 51 repeatedly performs the processes of steps S109 through S111 until a face detection timing arrives (while step S112 indicates NO). That is, in the control panel 3, the left eye visible region XL and the right eye visible region XR are controlled alternately to become transmissive and non-transmissive in synchronization with the left and right image display timing.

In other words, in the processes of steps S109 through S111, a shutter glasses unit Y is automatically generated in a position corresponding to the position of the pair of eyes of viewer M. The shutter glasses unit Y has the same function as conventional liquid crystal shutter glasses that have been used for viewing a three-dimensional image displayed with the time-division method, and is composed of a left eye visible region XL and a right eye visible region XR.

Therefore, viewer M located in front of the control panel 3 sees the left eye image only with the left eye through the left eye visible region XL during the left eye image display period, and sees the right eye image only with the right eye through the right eye visible region XR during the right eye image display period.

Next, when a face detection timing arrives (step S112: YES), CPU 51 again performs processes of steps S101 through S108 and updates information on the left eye visible region XL and the right eye visible region XR, as well as information on all the cells located in both regions. Then, CPU 51 repeats processes of steps S109 through S111. Therefore, when a face of the viewer (positions of both eyes) moves up and down, and left and right while the shutter glasses unit Y to be used by the viewer is being generated on the control panel 3, the shutter glasses unit Y also moves following the movement of the face of the viewer (positions of both eyes).

Additionally, when CPU 51 determines that no viewer is present within a predetermined distance range from the control panel 3 (step S103: NO or step S105: NO), CPU 51 performs the following processes. If the liquid crystal element 32 is in the driving mode (step S114: YES), CPU 51 stops the driving of the liquid crystal element 32 (step S115). That is, if a shutter glasses unit Y has been generated on the control panel 3, CPU 51 eliminates the shutter glasses Y. Then, CPU 51 returns to the step S101 process. Conversely, if the liquid crystal element 32 is not in the driving mode, that is, if the shutter glasses unit Y is not being generated (step S114: NO), CPU 51 directly returns to the step S101 process.

As described above, when the control panel 3 is used for a time-division three-dimensional image display device, the shutter glasses unit Y can automatically be generated in a position on the control panel 3 corresponding to the position of viewer M's eyes, and the generated shutter glasses unit Y can be made to follow the movement of the face of viewer M (positions of both eyes). Therefore, a viewer who does not wear liquid crystal shutter glasses for a three-dimensional viewing can see a three-dimensional image without being at a particular viewing position.

Further, when the control panel 3 is used for a time-division three-dimensional image display device, the control panel 3 only needs to have an optical shutter function of the liquid crystal element 32. That is, when the control panel 3 is used for the time-division three-dimensional image display device, the control panel 3 may be constituted of a liquid crystal element 32 without polarization direction control element 31.

Also, when the control panel 3 is used for the time-division three-dimensional image display device and the shutter glasses unit Y is generated on the control panel 3, the size, shape, and arrangement of the left and right visible regions XL and XR can be modified as needed. The control of the general area of the control panel 3, i.e. the area where the shutter glasses unit Y is not generated, as well as the timing for generation of the shutter glasses unit Y, may be modified as needed in a manner similar to above-described various examples in which the polarized glasses unit X is generated on the control panel 3. Also, when the control panel 3 is used for the time-division three-dimensional image display device, the configuration of the liquid crystal element 32 or the like may be modified as needed in a manner similar to those cases in which the control panel 3 is used for a three-dimensional image display device using the polarization filter method.

What is claimed is:

1. A three-dimensional image viewing device comprising:
a control panel having a plurality of pixels arranged in a predetermined region;
a position identifying unit that identifies a right eye position and a left eye position of a user viewing a display screen on which a left eye image and a right eye image are displayed, the user viewing said display screen through said predetermined region of said control panel configured to be interposed between said user and said display screen; and
a control circuit that controls said plurality of pixels such that at least part of said pixels arranged in a region corresponding to said right eye position identified by said position identifying unit transmits light only from said right eye image, and such that at least part of said pixels arranged in a region corresponding to said left eye position identified by said position identifying unit transmits light only from said left eye image.

2. A three-dimensional image viewing device comprising:
a control panel having a plurality of first pixels for a left eye image and a plurality of second pixels for a right eye image, the plurality of first pixels and the plurality of second pixels being arranged respectively in predetermined regions;
a position identifying unit identifying a right eye position and a left eye position of a user viewing a display screen on which said left eye image and said right eye image are displayed, the user viewing said display screen through said predetermined regions of said control panel configured to be interposed between said user and said display screen; and
a control circuit controlling said first pixels and said second pixels of said control panel,
wherein said first pixels are configured to be switchable between a first mode in which both first light and second light are blocked and a second mode in which said first light is transmitted and said second light is blocked, the first light being light from said left eye image and the second light being light from said right eye image,
wherein said second pixels are configured to be switchable between said first mode and a third mode in which said first light is blocked and said second light is transmitted, and
wherein said control circuit controls said first pixels and said second pixels in a region that corresponds to said left eye position identified by said position identifying unit such that said first pixels in that region enter said second mode and said second pixels in that region enter said first mode, and controls said first pixels and said second pixels in a region that corresponds to said right eye position identified by said position identifying unit such that said first pixels in that region enter said first mode and said second pixels in that region enter said third mode.

3. The three-dimensional image viewing device according to claim 2, wherein said first light and said second light are polarized such that their respective polarization modes are different from each other on said display screen.

4. The three-dimensional image viewing device according to claim 3, wherein said control panel comprises:
a polarization direction control element having retardation films disposed in a striped pattern at predetermined intervals, the retardation film generating a retardation of a one-half wavelength in a visible light of a predetermined wavelength; and
a liquid crystal element of normally white mode.

5. The three-dimensional image viewing device according to claim 4, wherein said retardation film is disposed so as to correspond only to said second pixels.

6. The three-dimensional image viewing device according to claim 5, wherein said first light is linearly polarized in a first direction on said display screen, and said second light is linearly polarized in a second direction that is perpendicular to said first direction on said display screen.

7. The three-dimensional image viewing device according to claim 6, wherein said liquid crystal element comprises a pair of polarizers disposed so that respective polarization axes thereof cross each other at a right angle, and a polarizer of the pair of polarizers that is disposed closer to said display screen is disposed in such a manner as to place a polarization axis of the polarizer in parallel with said first direction.

8. The three-dimensional image viewing device according to claim 7, wherein said liquid crystal element has a liquid crystal layer sandwiched between said pair of polarizers, liquid crystal molecules in said liquid crystal layer being configured to rotate a polarization direction of a visible light of a predetermined wavelength passing through the liquid crystal layer by 90 degrees when an OFF voltage is applied to said liquid crystal layer, and being configured not to rotate the polarization direction thereof when an ON voltage is applied thereto.

9. The three-dimensional image viewing device according to claim 2, wherein with respect to a region on said control panel other than regions corresponding to said identified right eye and left eye positions, said control circuit controls said first pixels to enter said second mode, and controls said second pixels to enter said third mode.

10. A three-dimensional image viewing device comprising:
a control panel having first pixels for a left eye image and second pixels for a right eye image, the plurality of first pixels and the plurality of second pixels being disposed respectively in predetermined regions;
a position identifying unit identifying a right eye position and a left eye position of a user viewing a display screen on which said left eye image and said right eye image are displayed, the user viewing said display screen through said predetermined regions of said control panel configured to be interposed between said user and said display screen; and
a control circuit controlling said first pixels and said second pixels on said control panel,
wherein said first pixels are configured to be switchable between a first mode in which both first light and second light are blocked and a second mode in which said first light is transmitted and said second light is blocked, the first light being light from said left eye image and the second light being light from said right eye image,
wherein said second pixels are configured to be switchable between said first mode and a third mode in which said first light is blocked and said second light is transmitted, and
wherein said control circuit controls said first pixels and said second pixels so as to generate, on said control panel, a three-dimensional image viewing glasses unit for said user at a position that is determined in accordance with the locations of the right eye and the left eye identified by said position identifying unit.

11. The three-dimensional image viewing device according to claim 10, wherein said control circuit generates a polarized glasses unit as said three-dimensional image viewing glasses unit.

12. The three-dimensional image viewing device according to claim 10, wherein said control circuit, after generating said three-dimensional image viewing glasses unit on said control panel, eliminates said three-dimensional image viewing glasses unit when a predetermined period of time has passed.

13. The three-dimensional image viewing device according to claim 10, wherein said control circuit changes the position of said three-dimensional image viewing glasses unit in accordance with a change in the right eye and left eye positions identified by said position identifying unit.

14. The three-dimensional image viewing device according to claim 10, wherein said three-dimensional image viewing glasses unit comprises a left eye visible region and a right eye visible region, and
wherein said control circuit controls said first pixels and said second pixels in the left eye visible region such that said first pixels in the left eye visible region enter said second mode and said second pixels in the left eye visible region enter said first mode, and controls said first pixels and second pixels in the right eye visible region such that said first pixels in the right eye visible region enter said first mode and said second pixels in the right eye visible region enter said third mode.

15. A three-dimensional image viewing device comprising:
a control panel having a plurality of pixels disposed in a predetermined region;
a position identifying unit identifying a right eye position and a left eye position of a user viewing a display screen on which a left eye image and a right eye image are alternately displayed in a time-division manner, the user viewing said display screen through said predetermined region of said control panel configured to be interposed between said user and said display screen; and
a control circuit that controls said plurality of pixels such that a light transmission state of the pixels disposed in a region corresponding to said left eye position identified by said position identifying unit differs from a light transmission state of the pixels disposed in a region corresponding to said right eye position identified by said position identifying unit.

16. The three-dimensional image viewing device according to claim 15, wherein when said left eye image is displayed on said display screen, said control circuit controls said pixels in said region corresponding to said left eye position to be transmissive, and controls said pixels in said region corresponding to said right eye position to be non-transmissive, and
wherein when said right eye image is displayed on said display screen, said control circuit controls said pixels in said region corresponding to said left eye position to be non-transmissive, and controls said pixels in said region corresponding to said right eye position to be transmissive.

17. A three-dimensional image viewing device comprising:
a control panel having a plurality of pixels disposed in a predetermined region;
a position identifying unit identifying a right eye position and a left eye position of a user viewing a display screen on which a left eye image and a right eye image are alternately displayed in a time-division manner, the user viewing said display screen through said predetermined region of said control panel configured to be interposed between said user and said display screen; and
a control circuit that controls said plurality of pixels to generate a three-dimensional image viewing glasses unit on said control panel, the three-dimensional image viewing glasses unit being generated for said user in accordance with said right eye position and said left eye position identified by said position identifying unit.

18. The three-dimensional image viewing device according to claim 17, wherein a three-dimensional image viewing glasses unit comprises a left eye visible region and a right eye visible region,
wherein when said left eye image is displayed on said display screen, said control circuit controls said pixels in said left eye visible region to be transmissive and controls said pixels in said right eye visible region to be non-transmissive, and
wherein when said right eye image is displayed on said display screen, said control circuit controls said pixels in said left eye visible region to be non-transmissive and controls said pixels in said right eye visible region to be transmissive.

19. A three-dimensional image display device comprising:
a projector projecting a left eye image and a right eye image on a screen;
a control panel having a plurality of pixels disposed in a predetermined region;
a position identifying unit identifying a right eye position and a left eye position of a user viewing a display screen, the user viewing said display screen through said predetermined region of said control panel that is configured to be interposed between said user and said screen; and
a control circuit that controls said plurality of pixels such that at least part of said pixels disposed in a region corresponding to said right eye position identified by said position identifying unit transmits light only from said right eye image, and such that at least part of said pixels disposed in a region corresponding to said left eye position identified by said position identifying unit transmits light only from said left eye image.
